(19) United States
(12) Patent Application Publication
(10) Pub. No.: US 2017/0259416 A1
(43) Pub. Date: Sep. 14, 2017

(54) SHEET MATERIAL APPLICATION TOOL

(71) Applicant: Geek Wraps, Inc., Oakland Park, FL (US)

(72) Inventors: Kenneth J. Calman, Fort Lauderdale, FL (US); Kathryn S. Calman, Fort Lauderdale, FL (US)

(21) Appl. No.: 15/069,354

(22) Filed: Mar. 14, 2016

(51) Int. Cl. B25B 33/00; B44D 3/22

(52) U.S. Cl. CPC B25B 33/00; B44D 3/22

(57) ABSTRACT

A sheet material application tool is provided that includes a longitudinal body, a first portion at a first end of the longitudinal body, and a second portion at a second end of the longitudinal body. The first portion includes a substantially flat edge defining a first distal end of the first portion of the longitudinal body. The second portion includes a hook defining a second distal end of the second portion of the longitudinal body.

### FIELD OF THE DISCLOSURE

The present disclosure relates to a tool for applying adhesive sheet material.

### BACKGROUND OF THE DISCLOSURE

Adhesive sheet materials are becoming the increasingly popular choice for advertising or otherwise displaying graphics on signs, automobiles, indoor and outdoor walls, indoor and outdoor floors, indoor and outdoor ceilings, buildings, and numerous other surfaces. Adhesive sheet materials typically have a display side bearing desired graphics, colors, texture, images, and/or text, and an application side that is coated with an adhesive substance and allows for application to various surfaces. The adhesive sheet material is typically applied in oversized sections and then cut or shaped to the desired shape and size. The size of the oversized sections and the size of the surface to which the adhesive sheet material is being applied vary greatly depending on the application.

One type of adhesive sheet material commonly used in the vehicle wrap industry is vinyl paint wrap. Although vinyl paint wraps are common, vehicles can be customized using a variety of adhesive sheet materials and the customization can include, but is not limited to including, body color change, texture change, and/or the application of text and/or graphics.

Adhesive sheet materials are applied to surfaces that have a variety of unique features, such as contours, welded obstacles, edges, fasteners, textures, and elements such as handles or windows. It is desirable to shape the adhesive sheet material around the surfaces' unique features. The adhesive sheet material is best applied once gently heated during the application process, the heat serving both to activate the adhesive and to render the adhesive sheet material more pliable and thus amenable to compliance with the surface and its unique features. Generally, a heat source, such as a propane or other combustible gas torch, or an electric heat gun, is used to heat the adhesive sheet material.

Application of adhesive sheet material is a pressure-sensitive process. Applying the wrong amount of pressure can result in improper installation of the adhesive sheet material. Difficulties often arise during application of adhesive sheet materials to variations in the surface or irregular surface features, such as contours, welded obstacles, edges, fasteners, textures, and elements such as handles or windows. Issues affecting the final appearance of the wrapped surface can arise if too little, too much, or non-uniform pressure is applied when installing the adhesive sheet material to variations in the surface or irregular surface features. These issues include gaps, air bubbles, or air-pockets between the surface and the adhesive sheet material, as well as post application lifting of the adhesive sheet material from the surface caused by shrinkage of the adhesive sheet material after being overstretched. If the adhesive sheet material is not properly adhered to the surface, it can result in aesthetic problems, peeling off of the adhesive sheet material, and/or premature delamination from the adhesive sheet material causing future failure.

Installers use multiple tools and supplies when applying adhesive sheet material, which makes storage of and access to a particular tool between uses particularly challenging.

Accordingly, there is a need for a device to facilitate the positioning, affixing, applying of pressure, and smoothing of the adhesive sheet material to the desired surface. Further, there exists a need for a device that facilitates placement of, and access to, the device while the user applies the adhesive sheet material to a surface.

### SUMMARY OF THE DISCLOSURE

In accordance with a first embodiment of present disclosure, a sheet material application tool is provided comprising a longitudinal body, a first portion at a first end of the longitudinal body, the first portion including a substantially flat edge defining a first distal end of the first portion of the longitudinal body, and a second portion at a second end of the longitudinal body, the second portion including a hook defining a second distal end of the second portion of the longitudinal body.

The hook may include a terminus that points in a direction that is substantially perpendicular to an axis defined by the longitudinal body. The edge may extend in a direction that is substantially perpendicular to an axis defined by the longitudinal body. The tool may further comprise a sleeve disposed at a central portion of the longitudinal body. The tool may further comprise a magnet disposed at a central portion of the longitudinal body. The tool may further comprise the sleeve disposed at the central portion of the longitudinal body, wherein the central portion of the longitudinal body includes a recess configured to support the magnet, the sleeve securing the magnet in the recess. The first portion may include a first surface and a second surface that taper from the central portion to the first distal end of the first portion of the longitudinal body.

In accordance with another embodiment of the present disclosure, a sheet material application tool is provided comprising a longitudinal body, a first portion at a first end of the longitudinal body, the first portion including a substantially flat edge defining a first distal end of the first portion of the longitudinal body, the edge extending in a first direction that is substantially perpendicular to an axis defined by the longitudinal body, and a second portion at a second end of the longitudinal body, the second portion including a hook defining a second distal end of the second portion of the longitudinal body, the hook including a terminus that points in a second direction that is substantially perpendicular to the axis defined by the longitudinal body.

The first direction and the second direction may be equal. The tool may further comprise a sleeve disposed at a central portion of the longitudinal body. The first portion may include a first surface and a second surface that taper from the central portion to the first distal end of the first portion of the longitudinal body. The tool may further comprise a magnet disposed at the central portion of the longitudinal body. The central portion of the longitudinal body may include a recess configured to support the magnet, the sleeve securing the magnet in the recess.

In accordance with another embodiment of the present disclosure, a sheet material application tool is provided comprising a longitudinal body, a first portion at a first end of the longitudinal body, the first portion including a substantially flat edge defining a first distal end of the first portion of the longitudinal body, a second portion at a second end of the longitudinal body, the second portion including a hook defining a second distal end of the second portion of the longitudinal body, and a magnet disposed at a central portion of the longitudinal body.

The hook may include a terminus that points in a direction that is substantially perpendicular to an axis defined by the longitudinal body. The substantially flat edge may extend in a direction that is substantially perpendicular to an axis defined by the longitudinal body. The hook may include a terminus that points in a direction that is substantially perpendicular to an axis defined by the longitudinal body and the substantially flat edge may extend in a direction that is substantially perpendicular to the axis defined by the longitudinal body. The tool may further comprise a sleeve disposed at the central portion of the longitudinal body. The central portion of the longitudinal body may include a recess configured to support the magnet, the sleeve securing the magnet in the recess. The first portion may include a first surface and a second surface that taper from the central portion to the first distal end of the first portion of the longitudinal body.

### BRIEF DESCRIPTION OF THE DRAWINGS

FIG. 1 is a perspective view of a sheet material application tool in accordance with one embodiment of the present disclosure;

FIG. 2 is a perspective view of a sheet material application tool in accordance with one embodiment of the present disclosure;

FIG. 3 is a left side elevation view of a sheet material application tool in accordance with one embodiment of the present disclosure;

FIG. 4 is a front side elevation view of a sheet material application tool in accordance with one embodiment of the present disclosure;

FIG. 5 is a rear side elevation view of a sheet material application tool in accordance with one embodiment of the present disclosure;

FIG. 6 is a right side elevation view of a sheet material application tool in accordance with one embodiment of the present disclosure;

FIG. 7 is a perspective view of a sheet material application tool in accordance with one embodiment of the present disclosure;

FIG. 8 is a left side elevation view of a sheet material application tool in accordance with one embodiment of the present disclosure; and

FIG. 9 is a front side elevation view of a sheet material application tool in accordance with one embodiment of the present disclosure.

### DETAILED DESCRIPTION

In accordance with the foregoing summary, the following is a detailed description of the embodiments of the disclosure, which are considered to be the best modes thereof. The methods and systems herein described are not intended to be exhaustive or to limit the disclosure to the precise forms disclosed.

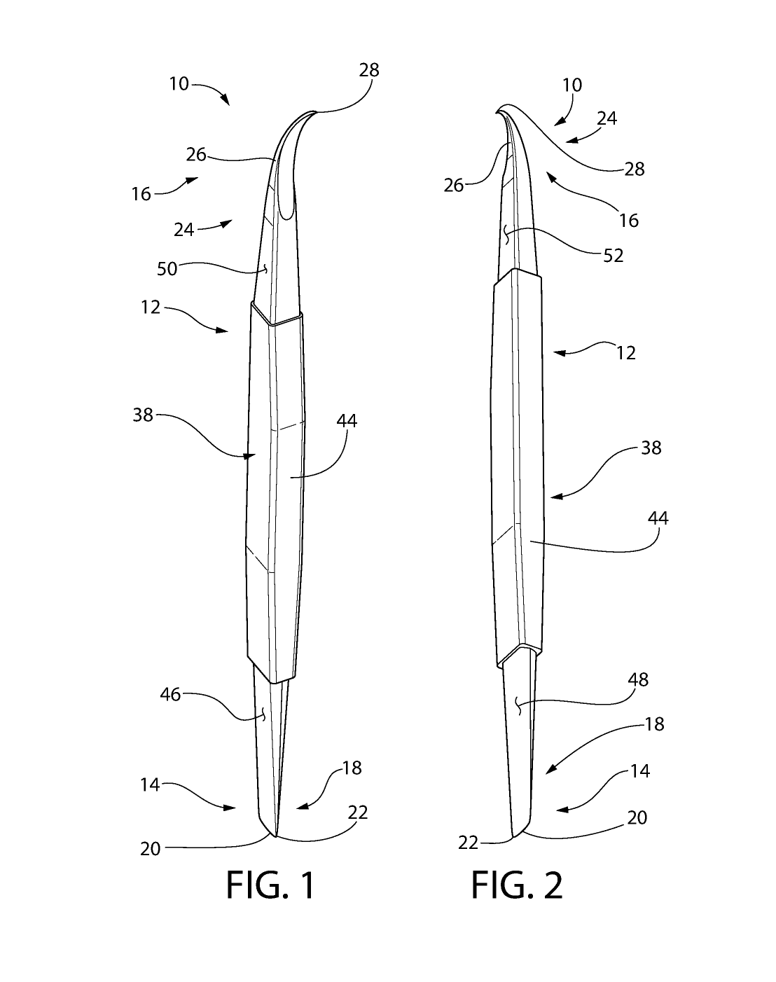

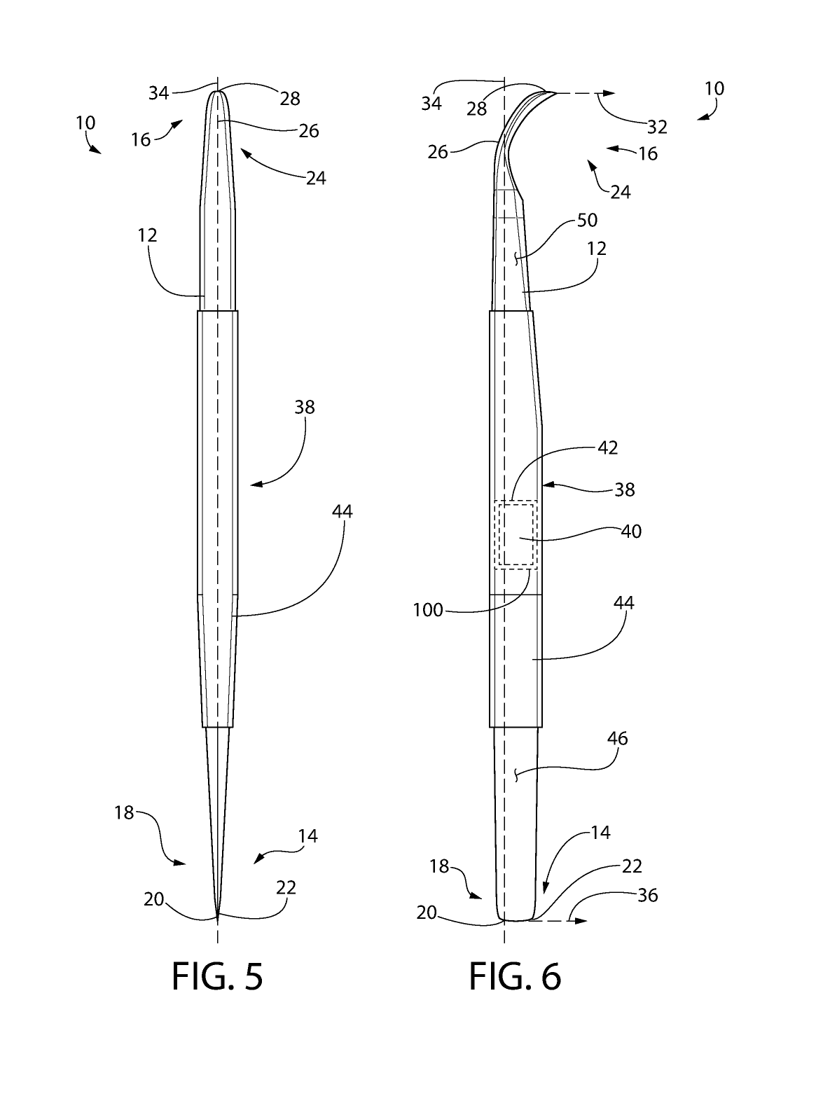

Reference is now made to FIGS. 1-6, which illustrate a sheet material application tool 10 in accordance with an embodiment of the present disclosure. The sheet material application tool 10 includes a longitudinal body 12, a first portion 14, and a second portion 16. The longitudinal body 12 in some embodiments is a single, monolithic, or integral piece of material. The longitudinal body 12 is multiple pieces in other embodiments. In one or more embodiments, the longitudinal body 12 is made from a polymer, elastomer, metal, or composite material. In an embodiment, the longitudinal body 12 is flexible and/or resilient. In an embodiment, the longitudinal body 12 has a Shore D hardness between 50 and 100.

The longitudinal body 12 in the illustrated embodiment has a rectangular cross section. In one or more embodiments, the body 12 has a square, round, triangular, or other polygonal cross section.

The first portion 14 is located at a first end 18 of the longitudinal body 12 and includes a substantially flat edge 20 defining a first distal end 22 of the first portion 14 of the longitudinal body 12. The first distal end 22 is the longitudinal boundary of the longitudinal body 12 of the tool 10 at the first end 18 in an embodiment. In one embodiment, the first portion 14 includes a first surface 46 and a second surface 48 that taper from a central portion 38 to the first distal end 22 of the first portion 14 of the longitudinal body 12. The first surface 46 or the second surface 48 or both surfaces 46, 48 may be angled inward toward the first distal end 22 to form the taper from the central portion 38 to the first distal end 22. The first surface 46 or the second surface 48 may be parallel to, and not angled with respect to, the surface of the central portion 38 in an embodiment. Similarly, in another embodiment, the first portion 14 includes a step (not shown) on one or both of the first surface 46 and the second surface 48 such that the thickness of the tool reduces in the direction toward the first distal end 22 of the first portion 14 of the longitudinal body 12. In one or more embodiments, the distal end 22 is not flat, but rounded, pointed, or serrated, or includes any other geometry known by a person with ordinary skill in the art. In an embodiment, the distal end 22 includes a frusto-conical point. In an embodiment, the distal end 22 includes the convergence of four tapered sides to a point at the distal end 22.

The second portion 16 is located at a second end 24 of the longitudinal body 12 and includes a hook 26 defining a second distal end 28 of the second portion 16 of the longitudinal body 12. The second distal end 28 is the longitudinal boundary of the longitudinal body 12 of the tool 10 at the second end 24 in an embodiment. In one embodiment, the second portion 16 includes a third surface 50 and a fourth surface 52 that taper from the central portion 38 to the second distal end 28 of the second portion 16 of the longitudinal body 12.

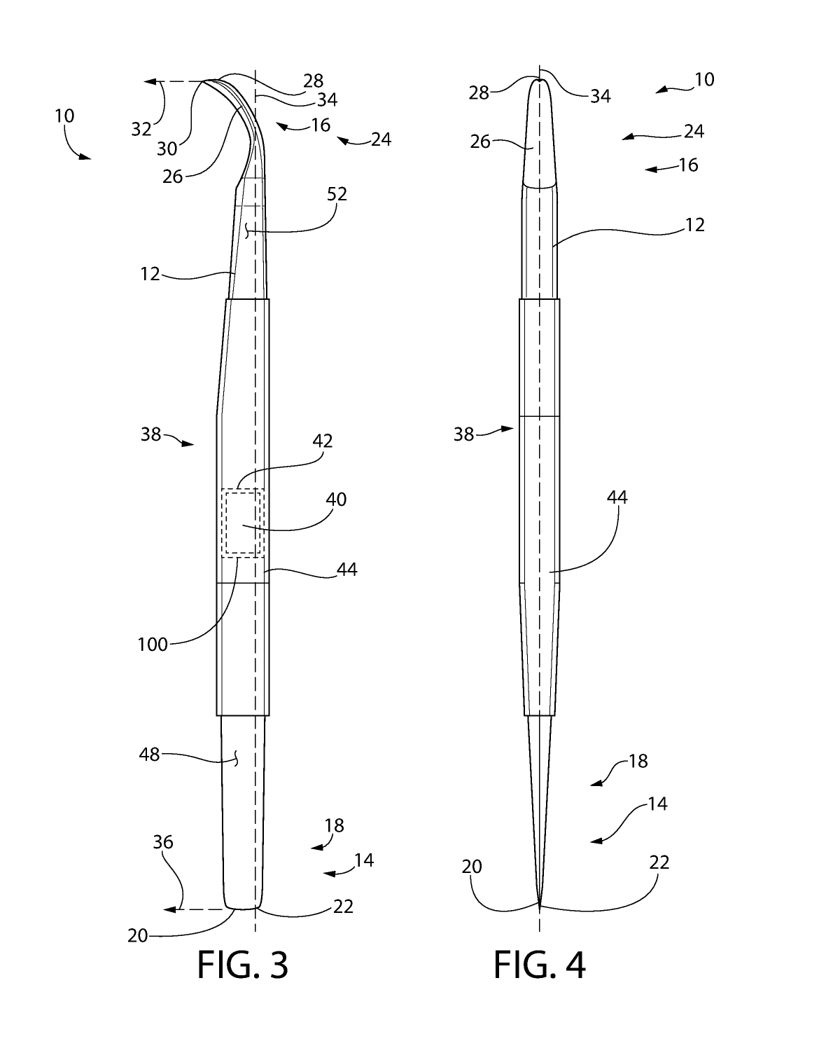

As illustrated in the embodiment of FIGS. 3-6, the hook 26 includes a terminus 30 that points in a first direction 32 that is substantially perpendicular to an axis 34 defined by the longitudinal body 12. The terminus 30 of one embodiment has a sharp point with a diameter between 0.01 mm and 0.5 mm. The edge 20 of one embodiment has a sharp edge with an edge tip diameter between 0.01 mm and 1 mm.

In the embodiment illustrated in FIGS. 3 and 6, the edge 20 extends in a second direction 36 that is substantially perpendicular to the axis 34 defined by the longitudinal body 12. The first direction 32 and the second direction 36 are equal in one embodiment. The first direction and the second direction are substantially parallel or substantially equal in one or more embodiments. The body 12 extends in a substantially straight line through the axis 34 in an embodiment. In an embodiment, at least part of the hook 26 and/or the second distal end 28 is spaced from the axis 34 with the remaining portions of the body 12 extending in a substantially straight line through the axis 34. In an embodiment, the hook 26 curves away from the axis 34 toward the second distal end 28.

In some embodiments, the tool 10 further includes a sleeve 44 disposed at a central portion 38 of the longitudinal body 12. The sleeve 44 in one or more embodiments includes grip tape, electrical tape, or any other tape material wrapped around the central portion 38, any such tape or other material coupled to or disposed on one or more sides of the tool 10, and/or any strip or piece of material inlaid on or in one or more sides of the tool 10. The sleeve 44 in an embodiment includes a plurality of sleeves 44. The sleeve 44 of one or more embodiments is composed of an elastomeric and/or foam material. The sleeve 44 of one or more embodiments includes a material of cloth, vinyl, leather, or other pliable material known in the art. The sleeve 44 is compliant, soft, or resilient and/or has a surface with a high coefficient of friction to provide a gripping surface in one embodiment to assist the user with gripping the tool 10 while in use. In an embodiment, the sleeve 44 is coupled to the central portion 38 of the body 12 in an interference fit. In an embodiment, the sleeve 44 is coupled to the central portion 38 by shrink-fitting. In an embodiment, the sleeve 44 is releasably coupled to a central portion 38 via stitching. In another embodiment, the sleeve 44 is coupled to a central portion 38 via an adhesive material.

The tool 10 includes a magnet 40 disposed at the central portion 38 of the longitudinal body 12 in an embodiment. The magnet 40 of one embodiment is a rare earth magnet. The magnet 40 of one or more embodiments is coupled to the central portion 38 of the body 12 by adhesive, a fastener, interference fit, or is held in place by the sleeve 44.

In the illustrated embodiment, the central portion 38 of the longitudinal body 12 includes a recess 42 configured to support the magnet 40. In one embodiment, the recess is a cutout 100 that extends through the entire thickness of the central portion 38 and has a shape corresponding to the shape of the magnet 40. As one non-limiting example, the cutout 100 has a rectangular cross section and the magnet 40 has a rectangular cross section. In other embodiments, the magnet 40 and the cutout 100 are round, triangular, square, or cylindrical. In an embodiment, the magnet 40 is at least partially molded into the central portion 38. The sleeve 44 secures the magnet 40 in the recess 42 in an embodiment. Following placement of the magnet 40 into the recess 42, the sleeve 44 is positioned over the central portion 38 to prevent separation of the magnet 40 from the central portion 38. In an embodiment, the magnet 40 is stitched or sewn into the central portion 38. In a further embodiment, the sleeve 44 includes a magnetic material or has the magnet 40 integrally formed with the sleeve 44. In an embodiment, the sleeve 44 does not secure the magnet 40 and the magnet 40 is merely disposed at the central portion 38.

The magnet 40 or magnetic material allows for placement of the tool 10 against a surface that is ferromagnetic or made from a ferrous metal. As one non-limiting example, a user of the tool 10 may easily attach the tool 10 to a motor vehicle door or other nearby metallic surface in order to store the tool 10 temporarily. A user may also easily releasably attach the tool 10 to a metal tool box lid, tool caddy, stool, or workbench. A user may also easily releasably attach the tool 10 to one or more of the magnetic portions of a tool holder, such as the one shown in U.S. patent application Ser. No. 15/050,030. When the user has a need to use the tool 10, the tool 10 will be nearby and easily and conveniently accessible.

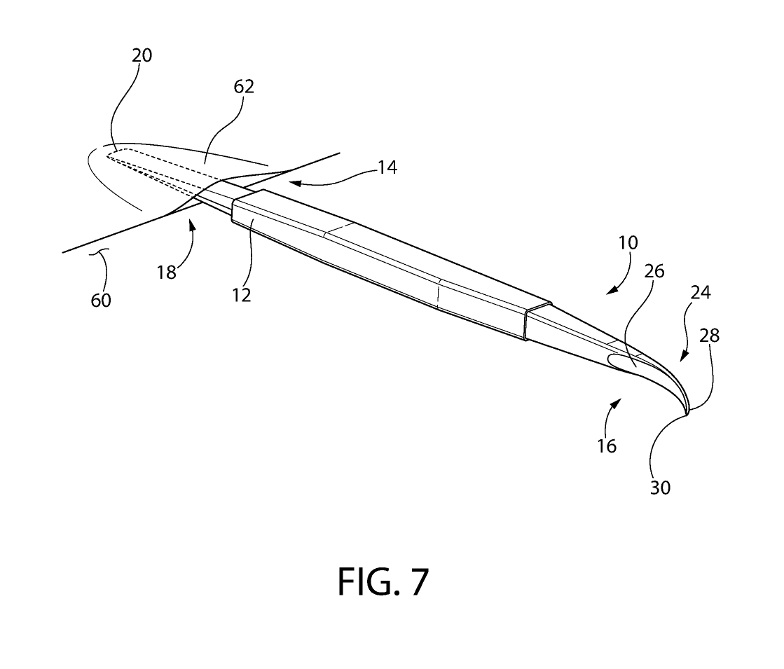

Referring now to FIG. 7, the tool 10 is illustrated in one embodiment of its use. The first portion 14 at the first end 18 of the longitudinal body 12 is shown inserted between a substrate 60 and a piece of sheet material 62. The edge 20 allows for insertion of the body 12 to a desired depth between the substrate 60 and the sheet material 62. In one embodiment, the tool 10 moves, releases, or relieves air bubbles (not shown) between the substrate 60 and the sheet material 62. In another embodiment, the edge 20 allows the tool 10 to separate the sheet material 62 from the substrate 60 at an edge 64 of the sheet material 62. Similarly, the second portion 16 at the second end 24 of the longitudinal body 12 may be inserted between the substrate 60 and the sheet material 62. As one non-limiting example, the hook 26 of the second distal end 28 of the second portion 16 of the longitudinal body 12 may be positioned between the substrate 60 and the sheet material 62 such that the terminus 30 is positioned between the substrate 60 and the sheet material 62. The hook 26 may be used to pry the sheet material 62 from the substrate 60 or move, release, or relieve air bubbles (not shown) between the substrate 60 and the sheet material 62. In one embodiment, the sleeve 44 includes a shrink-wrap material having an outer coating or surface that does not stick or adhere to the sheet material 62. Therefore, when the edge 20 or hook 26 is inserted between the substrate 60 and the sheet material 62, the tool 10 may be rotated, slid, or otherwise moved to vent air to or from the area between the substrate 60 and sheet material 62 without the central portion 38 binding with or pulling the sheet material 62.

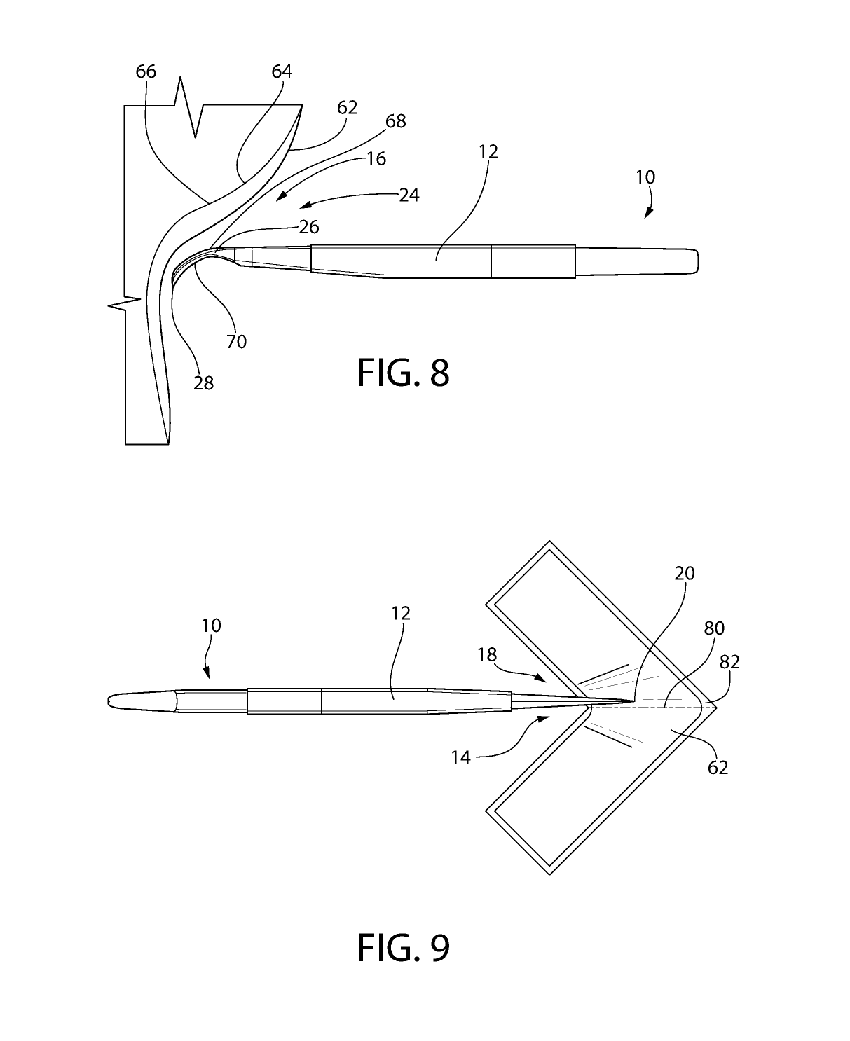

Referring now to FIG. 8, the tool 10 is illustrated in another embodiment of its use. The second portion 16 at the second end 24 of the longitudinal body 12 is utilized to apply the sheet material 62 to a substrate 64 having a concave, contoured, or curved surface 66. As one non-limiting example, a rear surface 68 of the hook 26 of the second distal end 28 of the second portion 16 of the longitudinal body 12 may be positioned against the sheet material 62 and pushed, pressed, or otherwise moved along the substrate 64. The curve of the rear surface 68 assists the adhesion of the sheet material 62 against the curved surface 66 of the substrate 64. Similarly, although not shown, a front surface 70 of the hook 26 is utilized in one embodiment to assist the adhesion of the sheet material 62 against a surface that is convex.

Additionally, a user (not shown) in one embodiment positions one of his or her fingers or thumbs against the front surface 70 of the hook 26 to grab, pinch, or hold an edge of the sheet material 62 or another substrate or material or to push the rear surface 68 against a surface. The shape or contour of the front surface 70 of the hook 26 corresponds with a contour of a finger or thumb in one embodiment. The tool 10 and the front surface 70 are configured to allow a user to position their thumb or finger against the front surface 70 in an embodiment. The user allows a material, including an edge of a material, to be positioned between the tip of the finger or thumb and the front surface 70 to grab, pinch, or hold the sheet material 62 in one embodiment to form tweezers using only the tool 10 and the user's thumb or finger.

Referring now to FIG. 9, the tool 10 is illustrated in another embodiment of its use. The first portion 14 at the first end 18 of the longitudinal body 12 is shown being positioned into an inside corner 80 of a substrate 82 such that the tool 10 is pushing, pressing, or otherwise moving the sheet material 62 toward the substrate 82. The sharpness of the edge 20 allows the sheet material 62 to adhere to the inside corner 80, as illustrated in FIG. 9. In one or more embodiments, the edge 20 or hook 26 of the tool 10 is utilized to move the sheet material 62 into adhesion with another inside or concave surface of any geometry or move or remove any air bubbles or pockets from between the sheet material 62 and a substrate.

Having shown and described particular embodiments of the disclosure, those skilled in the art will realize that many variations and modifications may be made to affect the described disclosure and still be within the scope of the claimed disclosure. Thus, many of the elements indicated above may be altered or replaced by different elements which will provide the same result and fall within the spirit of the claimed disclosure. It is the intention, therefore, to limit the disclosure only as indicated by the scope of the claims.

What is claimed is:

1. A sheet material application tool, comprising:
a longitudinal body;
a first portion at a first end of the longitudinal body, the first portion including a substantially flat edge defining a first distal end of the first portion of the longitudinal body; and
a second portion at a second end of the longitudinal body, the second portion including a hook defining a second distal end of the second portion of the longitudinal body.

2. The tool of claim 1, wherein the hook includes a terminus that points in a direction that is substantially perpendicular to an axis defined by the longitudinal body.

3. The tool of claim 1, wherein the edge extends in a direction that is substantially perpendicular to an axis defined by the longitudinal body.

4. The tool of claim 1, further comprising a sleeve disposed at a central portion of the longitudinal body.

5. The tool of claim 1, further comprising a magnet disposed at a central portion of the longitudinal body.

6. The tool of claim 5, further comprising a sleeve disposed at a central portion of the longitudinal body, wherein the central portion of the longitudinal body includes a recess configured to support the magnet, the sleeve securing the magnet in the recess.

7. The tool of claim 6, wherein the first portion includes a first surface and a second surface that taper from the central portion to the first distal end of the first portion of the longitudinal body.

8. The tool of claim 5, wherein the hook includes a terminus that points in a direction that is substantially perpendicular to an axis defined by the longitudinal body.

9. The tool of claim 5, wherein the edge extends in a direction that is substantially perpendicular to an axis defined by the longitudinal body.

10. The tool of claim 5, wherein the hook includes a terminus that points in a direction that is substantially perpendicular to an axis defined by the longitudinal body and the edge extends in the direction that is substantially perpendicular to the axis defined by the longitudinal body.

11. The tool of claim 5, further comprising a sleeve disposed at the central portion of the longitudinal body.

12. The tool of claim 11, wherein the central portion of the longitudinal body includes a recess configured to support the magnet, the sleeve securing the magnet in the recess.

13. The tool of claim 5, wherein the first portion includes a first surface and a second surface that taper from the central portion to the first distal end of the first portion of the longitudinal body.

14. A sheet material application tool, comprising:
a longitudinal body;
a first portion at a first end of the longitudinal body, the first portion including a substantially flat edge defining a first distal end of the first portion of the longitudinal body, the edge extending in a first direction that is substantially perpendicular to an axis defined by the longitudinal body; and
a second portion at a second end of the longitudinal body, the second portion including a hook defining a second distal end of the second portion of the longitudinal body, the hook including a terminus that points in a second direction that is substantially perpendicular to the axis defined by the longitudinal body.

15. The tool of claim 14, wherein the first direction and the second direction are equal.

16. The tool of claim 14, further comprising a sleeve disposed at a central portion of the longitudinal body.

17. The tool of claim 16, wherein the first portion includes a first surface and a second surface that taper from the central portion to the first distal end of the first portion of the longitudinal body.

18. The tool of claim 16, further comprising a magnet disposed at the central portion of the longitudinal body.

19. The tool of claim 18, wherein the central portion of the longitudinal body includes a recess configured to support the magnet, the sleeve securing the magnet in the recess.

20. A sheet material application tool, comprising:
a longitudinal body;
a first portion at a first end of the longitudinal body, the first portion including a substantially flat edge defining a first distal end of the first portion of the longitudinal body, the edge extending in a first direction that is substantially perpendicular to an axis defined by the longitudinal body;
a second portion at a second end of the longitudinal body, the second portion including a hook defining a second distal end of the second portion of the longitudinal body, the hook including a terminus that points in a second direction that is substantially perpendicular to the axis defined by the longitudinal body, wherein the first direction and the second direction are substantially equal;
a sleeve disposed at a central portion of the longitudinal body, wherein the first portion includes a first surface and a second surface that taper from the central portion to the first distal end of the first portion of the longitudinal body; and
a magnet disposed at the central portion of the longitudinal body, wherein the central portion of the longitudinal body includes a recess configured to support the magnet, the sleeve securing the magnet in the recess.
